(19) United States
(12) Patent Application Publication
(10) Pub. No.: US 2025/0360863 A1
(43) Pub. Date: Nov. 27, 2025

(54) HANDLE STRUCTURE OF CHAIN BINDER

(71) Applicant: STRONG YUN INDUSTRIAL CO.,LTD., TAOYUAN CITY (TW)

(72) Inventor: YEH-CHIEN CHOU, TAOYUAN CITY (TW)

(21) Appl. No.: 18/670,045

(22) Filed: May 21, 2024

(51) Int. Cl. B60P 7/08

(52) U.S. Cl. CPC B60P 7/083

(57) ABSTRACT

A handle structure of a chain binder contains: a pull bar and a grip assembly. The pull bar includes a body, a threaded tube received in the body, two threaded hooks, and a holder. The grip assembly includes a hollow extension, a rotatable stem, and a spring. The hollow extension has two fixing orifices, and the rotatable stem has a coupling orifice and a recess with a defining portion. The defining portion accommodates a limiter, and the spring is received in the recess of the rotatable stem. The rotatable stem is accommodated in the hollow extension, the limiter of the defining portion is inserted in the two fixing orifices of the hollow extension so that the rotatable stem abuts against the extension, and the coupling orifice of the rotatable stem corresponds to the holder of the pull bar and is rotatably connected with the rotary shaft of the holder.

### TECHNICAL FIELD

The present invention relates to a handle structure of a chain binder which is capable of operating the chain binder easily and stably.

### BACKGROUND

With reference to FIG. 7, a handle structure of a conventional chain binder, the chain binder contains a pull bar 10 and a grip assembly 30 made of metal. The pull bar 10 includes a body 11, a threaded tube received in the body 11, two threaded hooks 120 screwed with two sides of the threaded tube 12, a fixing seat 13 fixed on a bottom of the pull bar 10, and a rotary shaft 130 received in the seat 13. The grip assembly 30 includes a hollow extension 31, a rotatable block 32, a spring 33, and a coupling element 34. The hollow extension 31 has a first cavity 310 and a second cavity 311 which are spaced by a partition 312, and a through orifice 312A defined on the partition 312. The rotatable block 32 has a rotatable connection segment 320 and a fixed head segment 321, and the rotatable connection segment 320 has a defining orifice 320A horizontally extending. The rotatable connection segment 320 also has a limiting orifice 321A vertically extending. The fixed head segment 321 of the rotatable block 32 is received in the first cavity 310 of the hollow extension 31, the spring 33 is fitted on the coupling element 34, wherein a side of the spring 22 is forced by the coupling element 34, and the spring 33 and the coupling element 34 are accommodated in the second cavity 311 of the hollow extension 31, wherein the other side of the spring 33 abuts against the partition 312, and the coupling element 34 is fixed in the limiting orifice 321A of the fixed head segment 321 via the through orifice 312A of the partition 312. The defining orifice 320A of the rotatable connection segment 320 corresponds to the fixing seat 13 of the pull bar 10 and is fixed by the rotary shaft 130 of the fixing seat 13, such that the spring 33 is forced by the coupling element 34 to urge the rotatable block 32 to move. However, the coupling element 34 removes from the fixed head segment 321 of the rotatable block 32 after a period of using time. The first cavity 310, the second cavity 311 and the partition 312 of the hollow extension 31 are machined complicated and difficultly to cause high production cost and defective rate.

The present invention has arisen to mitigate and/or obviate the afore-described disadvantages.

### SUMMARY

The primary aspect of the present invention is to provide a handle structure of a chain binder which by which when the pull bar is rotated to 90 degrees, the hollow extension is pushed by the spring to move rearward or forward so that the grip assembly flexibly contacts with the grip assembly, thus operating the chain binder easily and stably.

To obtain above-mentioned aspect, a handle structure of a chain binder provided by the present invention contains: a pull bar and a grip assembly.

The pull bar includes a body formed on a top of the pull bar, a threaded tube received in the body, two threaded hooks screwed with two sides of the threaded tube, and a holder fixed on a bottom of the pull bar and configured to receive a rotary shaft.

The grip assembly includes a hollow extension, a rotatable stem, and a spring. The hollow extension has two fixing orifices defined on a top thereof, and the rotatable stem has a coupling orifice and a recess with a defining portion. The defining portion accommodates a limiter, and the spring is received in the recess of the rotatable stem. The rotatable stem is accommodated in the hollow extension, the limiter of the defining portion is inserted in the two fixing orifices of the hollow extension so that the rotatable stem abuts against the extension, and the coupling orifice of the rotatable stem corresponds to the holder of the pull bar and is rotatably connected with the rotary shaft of the holder.

Thereby, the coupling orifice of the rotatable stem corresponds to the holder of the pull bar and is rotatably connected with the rotary shaft of the holder, such that the pull bar is rotatably connected on a side of the grip assembly. The spring of the grip assembly is fixed between the rotatable stem and the hollow extension so that the rotatable stem abuts against the hollow extension to produce a resistant tension. When the pull bar is rotated to 90 degrees, the hollow extension is pushed by the spring to move rearward or forward so that the grip assembly flexibly contacts with the grip assembly, thus operating the chain binder easily and stably.

### BRIEF DESCRIPTION OF THE DRAWINGS

FIG. 1 is a perspective view showing the assembly of a handle structure of a chain binder according to a preferred embodiment of the present invention.

FIG. 2 is a perspective view showing the exploded components of the handle structure of the chain binder according to the preferred embodiment of the present invention.

FIG. 3 is a cross sectional view showing the assembly of the handle structure of the chain binder according to the preferred embodiment of the present invention.

FIG. 4 is another cross sectional view showing the assembly of the handle structure of the chain binder according to the preferred embodiment of the present invention.

FIG. 5 is a cross sectional view showing the operation of the handle structure of the chain binder according to the preferred embodiment of the present invention.

FIG. 6 is another cross sectional view showing the operation of the handle structure of the chain binder according to the preferred embodiment of the present invention.

FIG. 7 is a cross sectional view of a handle structure of a conventional chain binder.

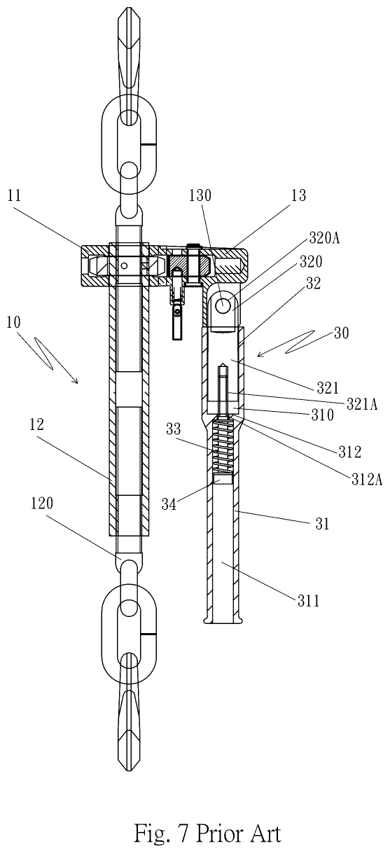

### DETAILED DESCRIPTION

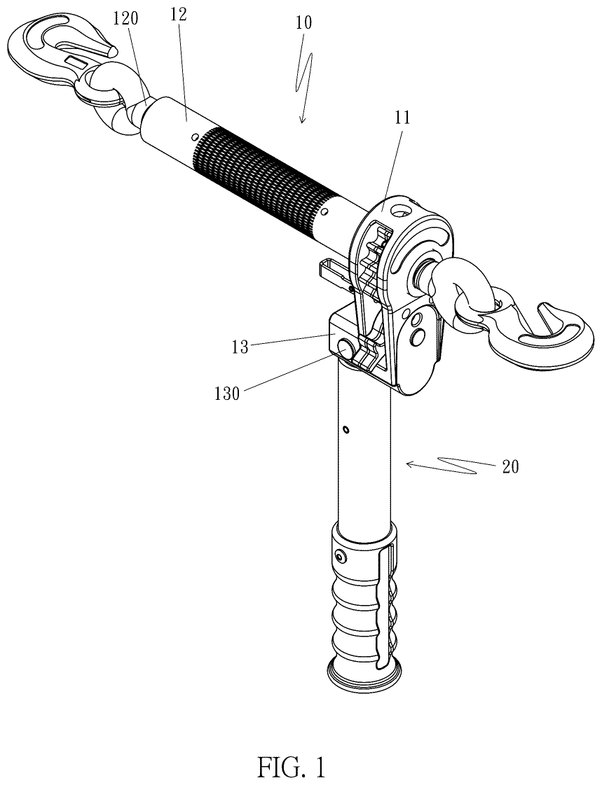

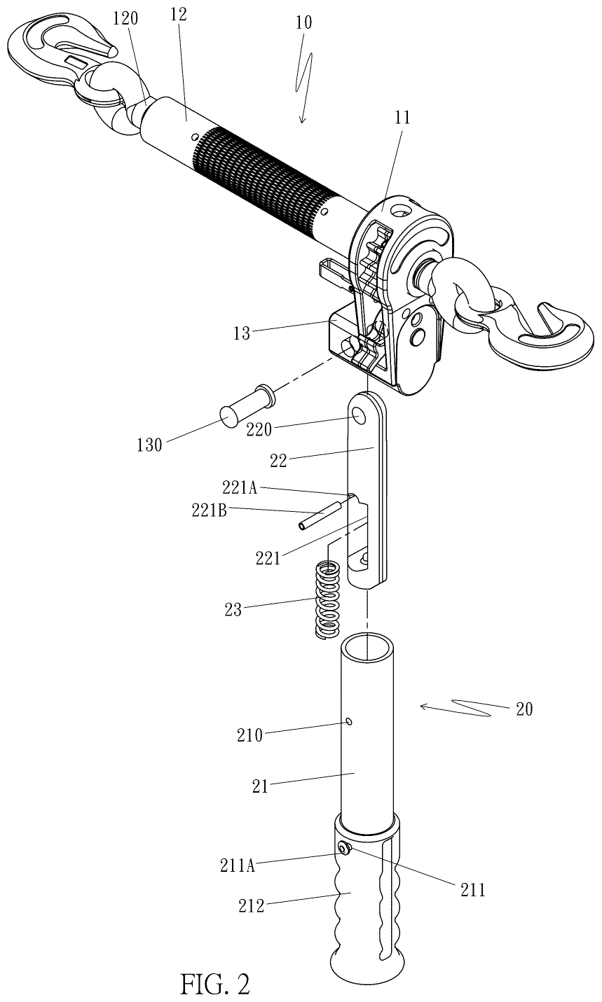

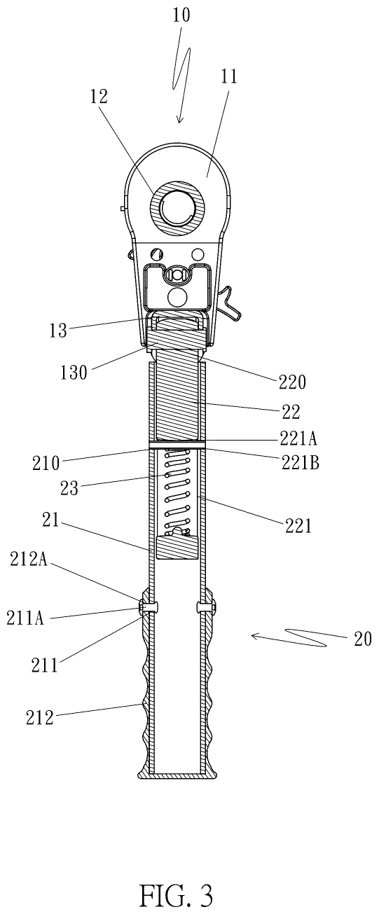

With reference to FIGS. 1-3, a handle structure of a chain binder according to a preferred embodiment of the present invention comprises:
a pull bar 10 including a body 11 formed on a top of the pull bar 10, a threaded tube 12 received in the body 11, two threaded hooks 120 screwed with two sides of the threaded tube 12, and a holder 13 fixed on a bottom of the pull bar 10 and configured to receive a rotary shaft 130; and
a grip assembly 20 including a hollow extension 21, a rotatable stem 22, and a spring 23, wherein the hollow extension 21 has two fixing orifice 210 defined on a top thereof, the rotatable stem 22 has a coupling orifice 220 and a recess 221 with a defining portion 221A, wherein the defining portion 221A accommodates a limiter 221B, and the spring 23 is received in the recess 221 of the rotatable stem 22, the rotatable stem 22 is accommodated in the hollow extension 21, and the limiter 221B of the defining portion 221A is inserted in the two fixing orifices 210 of the hollow extension 21 so that the rotatable stem 22 abuts against the extension 21, and the coupling orifice 220 of the rotatable stem 22 corresponds to the holder 13 of the pull bar 10 and is rotatably connected with the rotary shaft 130 of the holder 13.

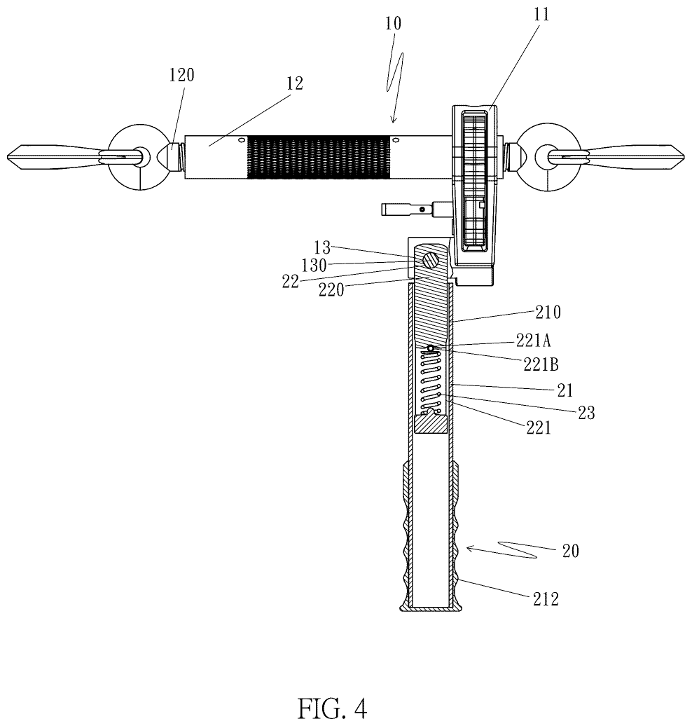

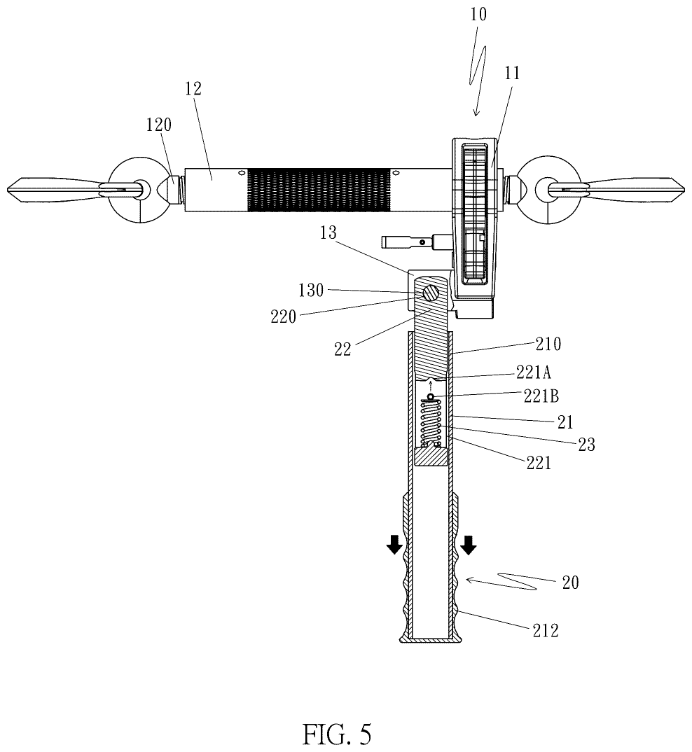

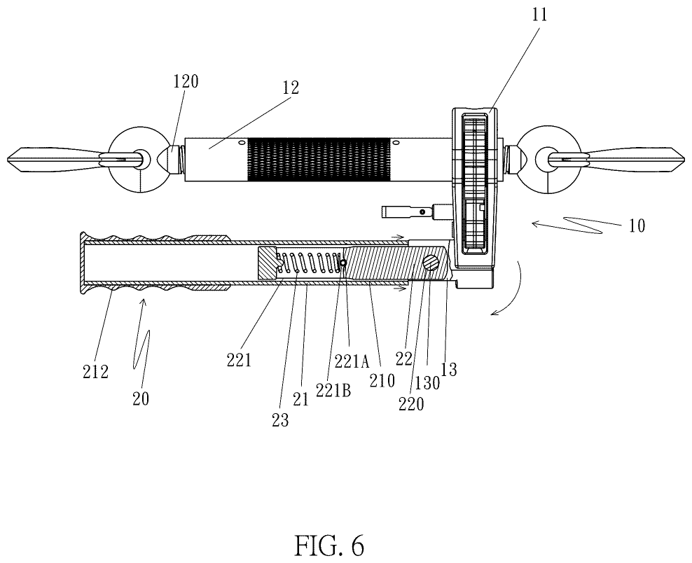

Referring to FIGS. 4-6, the coupling orifice 220 of the rotatable stem 22 corresponds to the holder 13 of the pull bar 10 and is rotatably connected with the rotary shaft 130 of the holder 13, such that the pull bar 10 is rotatably connected on a side of the grip assembly 20. The spring 23 of the grip assembly 20 is fixed between the rotatable stem 22 and the hollow extension 21 so that the rotatable stem 22 abuts against the hollow extension 21 to produce a resistant tension. When the pull bar 10 is rotated to 90 degrees, the hollow extension 21 is pushed by the spring 23 to move rearward or forward so that the grip assembly 10 flexibly contacts with the grip assembly 20, thus operating the chain binder easily and stably.

The hollow extension 21 of the grip assembly 20 has an anti-slip sleeve 212 fitted on a bottom of the hollow extension 21 to avoid a removal of the grip assembly 20.

The hollow extension 21 of the grip assembly 20 has at least one positioning orifice 211 defined on the bottom of the hollow extension 21 and configured to accommodating at least one locating element 211A, and the anti-slip sleeve 212 has at least one connection orifice 212A defined thereon, wherein the anti-slip sleeve 212 is fitted on the bottom of the hollow extension 21, and the at least one connection orifice 212A of the anti-slip sleeve 212 corresponds to the at least one positioning orifice 211 of the hollow extension 21, hence the at least one locating element 211A is fixed by the at least one positioning orifice 211, thus fixing the anti-slip sleeve 212 securely.

Each of the at least one positioning orifice 211 is configured to fix each of the at least one locating element 211A, when the anti-slip sleeve 212 is fitted on the bottom of the hollow extension 21, each connection orifice 212A of the anti-slip sleeve 212 is aligned with teach positioning orifice 211 of the hollow extension 21 and is fixed by each locating element 211A, thus fixing the anti-slip sleeve 212 securely.

The anti-slip sleeve 212 is made of flexible material to enhance a griping comfort.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A handle structure of a chain binder comprising:
a pull bar including a body formed on a top of the pull bar, a threaded tube received in the body, two threaded hooks screwed with two sides of the threaded tube, and a holder fixed on a bottom of the pull bar and configured to receive a rotary shaft; and
a grip assembly including a hollow extension, a rotatable stem, and a spring, wherein the hollow extension has two fixing orifices defined on a top thereof, and the rotatable stem has a coupling orifice and a recess with a defining portion, wherein the defining portion accommodates a limiter, and the spring is received in the recess of the rotatable stem, the rotatable stem is accommodated in the hollow extension, the limiter of the defining portion is inserted in the two fixing orifices of the hollow extension so that the rotatable stem abuts against the extension, and the coupling orifice of the rotatable stem corresponds to the holder of the pull bar and is rotatably connected with the rotary shaft of the holder.

2. The handle structure of the chain binder as claimed in claim 1, wherein the hollow extension of the grip assembly has an anti-slip sleeve fitted on a bottom of the hollow extension.

3. The handle structure of the chain binder as claimed in claim 1, wherein the hollow extension of the grip assembly has at least one positioning orifice defined on the bottom of the hollow extension and configured to accommodating at least one locating element, and the anti-slip sleeve has at least one connection orifice defined thereon, wherein the anti-slip sleeve is fitted on the bottom of the hollow extension, and the at least one connection orifice of the anti-slip sleeve corresponds to the at least one positioning orifice of the hollow extension, hence the at least one locating element is fixed by the at least one positioning orifice.

4. The handle structure of the chain binder as claimed in claim 1, wherein each of the at least one positioning orifice is configured to fix each of the at least one locating element, when the anti-slip sleeve is fitted on the bottom of the hollow extension, each connection orifice of the anti-slip sleeve is aligned with teach positioning orifice of the hollow extension and is fixed by each locating element.

5. The handle structure of the chain binder as claimed in claim 1, wherein the anti-slip sleeve is made of flexible material to enhance a griping comfort.
